(19) United States
(12) Patent Application Publication
(10) Pub. No.: US 2002/0111868 A1
(43) Pub. Date: Aug. 15, 2002

(54) Interactive system for the improvement of sales, production and management of retail points of sale, particularly for fast food

(76) Inventor: Jean-Claude Silvestre, Bouafle (FR)

Correspondence Address: IP Deprtment, Schnader Harrison Segal & Lewis, 1600 Market Street, 36th Floor, Philadelphia, PA, 19103, US

(21) Appl. No.: 09/775,981

(22) Filed: Feb. 2, 2001

(30) Foreign Application Priority Data
Dec. 18, 2000 (FR) 00/16500

(51) Int. Cl. G06F 17/60

(52) U.S. Cl. 705/16; 705/15

(57) ABSTRACT

This invention relates to a computer aided sales system intended for use in a retail point of sale, including at least one order taking device, a sales terminal and a server for communication between the different equipment in the system, characterized in that the server includes a recorder which records data originating from the order taking device, and a computer for analyzing data recorded in the data base to generate messages interacting with at least one item of equipment connected to the server.

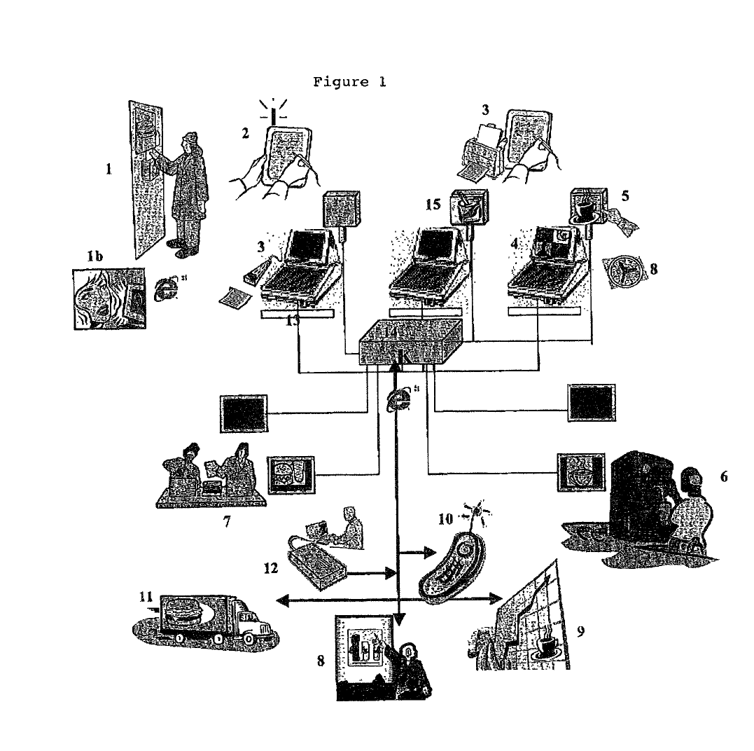

### PRIORITY APPLICATION

This application claims priority of French Patent Application No. 00/16500, filed Dec. 18, 2000.

### FIELD OF THE INVENTION

This invention relates to the field of computer systems intended for a retail point of sale, and particularly for sales management.

### BACKGROUND

Different solutions are known in the state of the art. For example, WO 8705425 describes a system for taking fast food orders comprising a panel with a number of keys each corresponding to an article that can be selected. The system recognizes the credit card and the customer's account, and the customer then uses the panel to input selected articles into the system. The selected articles are reproduced in a central room where the order is accepted.

After the order has been accepted, a credit form and a receipt are issued and displayed to the customer on the control panel, and the customer's account is debited by the amount to be paid for the order. The customer signs the form thus accepting the credit methods represented on the form and presents the form signed in exchange for the ordered articles.

EP 343194 describes a sales installation that comprises a management device connected to at least one point of sale equipment, each equipment comprising a touch sensitive input device, a first device for inputting data representative of at least one article comprising a first part of the touch sensitive input device, a second device for inputting order data comprising a second part of the touch sensitive input device, an execution device intended to perform at least one validation operation for a transaction related to the article, and a display device. At least part of the area of the display device consists of a transparent touch sensitive input device. The first part of the touch sensitive input device for the first device is located above a first area of the screen, this area displaying information about the articles. The second part of the touch sensitive input device related to the second input device is placed above a second area on the screen, this area displaying information about orders. The management device controls assignments of parts of the screen to the first and second area as a function of a first set of information related to possible transaction elements.

Thus, it would be advantageous to provide an improvement to sales, production and management systems intended for a retail point of sale.

### SUMMARY OF THE INVENTION

This invention relates to a computer aided sales system intended for use in a retail point of sale including at least order taking equipment, a sales terminal and a server for communication between the different equipment in the system, characterized in that the server includes means for recording data originating from the order taking equipment, and a computer for analyzing data recorded in the data base in order to generate messages interacting with at least one item of equipment connected to the server.

### BRIEF DESCRIPTION OF THE DRAWING

This invention will be better understood after reading a description of a non-limitative example embodiment below with reference to the attached drawing which shows a diagrammatic view of an architecture of a system according to the invention.

### DETAILED DESCRIPTION

This invention relates to a computer aided sales system intended for use in a retail point of sale comprising at least an order taking equipment, a sales terminal and a server for communication between the different equipment in the system characterized in that the server comprises means for recording data originating from order taking equipment, and a computer for analyzing data recorded in the data base to generate messages interacting with at least one item of equipment connected to the server.

Advantageously, the server comprises input-output interfaces for the connection of several types of peripherals, and a data base for the conversion of data formats originating from or intended for the different interconnected equipment, to the specific format for each of the items of equipment.

According to one variant, the server comprises a driver for the shop point of sale equipment [POS], providing communication between the data format for the point of sale POS equipment and the unique information format used by the server, and the specific adaptation of the different system means with the POS to enable two-way communication.

Advantageously, the server comprises a specific database to collect all possible cash till information and translate them ir. an appropriate manner for their destination peripherals.

According to a particular embodiment, the order taking equipment comprises a computer aided sales module that displays images or animates ordered products and enables the menu -to be input (by the customer), and the server comprises a module for statistical analysis and interpretation of the customer's behavior based on the typology of the customer and the time dated record of when the details were entered on the tray.

According to another variant, the server comprises a communication and warnings module for selectively transmitting warnings in real time (functional or technical) and for the automatic transmission of information to a host system as a function of information recorded in a parameter-controlled events table and a state of parameters supplied by system components.

According to another embodiment, the server comprises a dialog module for taking orders, that displays and takes interactive orders as a function of real time information from the server, to display information input on the till to the customer, and to return customer selections to the server to modify the order in real time.

Preferably, the server comprises a module for broadcasting of elements from the management module to peripheral management modules (passive) for display on a screen or a printer.

Turning now to the drawing, the system comprises a plurality of modules of equipment. A first series of modules is intended for sales functions. It comprises an order taking terminal (1) for the customer, and possibly an interface with the Internet network (1b) fox taking orders on line. This series of modules also comprises a portable peripheral composed of an order taking slate in a room connected by a radio link (2), and optionally equipped with a printer and a bar code reader (3). It also comprises equipment for taking orders at the counter. This equipment is used to detect the typology of the customer (4) for incentive computer aided sales (5).

For computer aided sales, the components are connected to a server (14) to:

retrieve information from the cash till and control the cash till (4, 14)

computer aided sales programs controlling the order terminal and printing a bar code ticket (1).

Building up the order and printing a bar code ticket through Internet (1b)

a portable peripheral composed of an order taking slate in a room connected through a radio link (2), and possibly equipped with a bar code printer (3)

read and immediate acquisition of bar code orders on the cash till (bar code reader) (3)

recording the customer typology before taking the order (4).

An order taking peripheral (2) comprising a touch sensitive screen facing the customer to:

display images or animate ordered products (5)

incite the customer to purchase an additional product (as a function of the customer typology, the time, promotions, the order, etc.) (5)

enable the customer to enter his menu (touch sensitive screen, programmed suggestions and incentives, assistance by the staff, etc.) (4, 5).

Use of these data exchanged for marketing purposes comprises:

a time-dated analysis of the tray composition method (8)

monitoring the behavior by customer type (9)

broadcasting of promotional messages (15)

production control

forwarding only useful information to each workstation (6)

preparation of dishes and composition of the tray while taking the order (7)

returning management information (warnings (10), reprocurement (11), personnel, etc.) in real time

remote maintenance of the system (12)

the use of cash tills and the existing management system

retrieval of information entered into the existing cash till (13)

control of the cash till from the server (14)

The server (14) enables any shop equipped with a recording cash till or a Point of Sales network (Point of Sales Terminal) to take advantage of new real time functions for selling articles, order preparation and back office management functions.

The server (14) operates like a universal instantaneous translator capable of performing the following in real time:

themes: POS systems to order taking, order preparation, order assembly and back office management peripherals. These peripherals are denoted peripheral management modules in the rest of this document.

versions: from these same peripheral management modules to the shop POS system.

The shop checks that POS information that is explicit to the cashier, but specific to the shop is translated into information that is relevant and understandable to the customer. This also guarantees that the detailed information generated by the server (14) about the transaction is of good quality and consistent.

The system according to the invention enables the shop to benefit from developments in direct marketing without needing to replace the cash till system. This system maintains its vital functions of legal recording of the order in accordance with the legal and tax regulations in force.

The server, which is preferably known as “Kebox,” is in the form of a box containing standard components available on the market (drivers, video cards, microprocessors, local network communication and telecommunication cards).

It comprises the following components:

a POS driver, depending on the POS system installed in the shop that controls communication between the POS data format and the Kebox unique information format. This driver also includes the specific adaptation (hardware/software/settings) necessary on the POS to enable two-way communication.

a specific data base (KBD) that collects all possible cash till information and their translations adapted to the destination peripheral management modules.

The server uses management and maintenance tools:

semantic POS information interpreter,

inspection and audit tool (uniqueness, duplicates, holes),

update tool (for example central maintenance of images/products),

simulation tool.

The server (14) also comprises a specific management unit that accepts the unique Kebox information format as input.

It prepares and broadcasts elements to the peripheral management modules as a function of:

information output by the POS driver,

translations obtained from the KBD database,

complementary processing enriching the information to be sent to the peripheral management module involved (for example, suggestion products for display on the customer screen),

idle time (substitution information, for example, promotion film on the customer screen).

It enables communication and maintenance (technical, parameters, data) and enables real time marketing use of the behavior of customers and shop management. Drivers for the peripheral management modules are used by the shop, and are unique for each type of peripheral management module function. They accept different types of peripheral equipment including passive peripherals (for example, printer, passive screen and the like) and active peripherals (for example, touch sensitive screen, microcomputer and the like).

Drivers perform functions such as Diffusion modules Kdiffu (unilateral communication, for example, for passive display to the production kitchen screen), Dialog modules Kcusto for taking orders (two-way communication, for example, display+order taking on a touch sensitive customer screen) and Prepaxation module Kbussi (preparation of elements to be communicated in real time, for example, send sales elements from the procurement system in real time).

The Kebox management unit comprises the following modules:

a computer aided sales module for displaying images or animate ordered products, incentive to purchase an additional product (depending on the typology of the customer, time, products already ordered, promotions, etc.) and the menu composition by the customer (touch sensitive screen, programmed suggestions and incentives, assistance by the staff and the like).

a module for the statistical analysis and interpretation of the customer behavior, making use of:

the customer typology (input on the cash till before the order is taken)

the time dated record of the detailed composition of the tray,

a communication and warnings module including:

interpretation of recorded retail orders,

selective transmission of warnings in real time (functional or technical),

automatic transmission of information to a host system

remote maintenance of the system.

It is built around a parameter controlled events table.

The server (14) uses the following functions/procedures:

Kcaptu: retrieval of information from the cash till; listening loop on the POS (for example, read video memory, capture keyboard keys, listen to the cash tills network, listening from all outputs, or contact point on an electronic card in the POS, listen to frequencies sent by the cash till and the like)

real time capture of POS transactions (including the typology of the customer)

write in the unique Kebox information format.

Kemul: control the cash till

POS emulation

activate specific POS parameters (for example, for input of the customer typology before the order is taken).

communication to the POS: wire communication (RS232 output, network, USB port and the like), radio (DECT link, Blue Tooth, infrared and the like) starting from various external peripherals, keyboard, bar code reader, touch sensitive screen, buttons, joystick, touch sensitive sensor, PC, machine in general.

The dialog order taking module Kcusto displays and takes interactive orders as a function of real time information on the KebQx to display information input on the cash till to the customer and to send keys pressed by the customer to the Kebox to modify the order in real time. This communication is two-way between the management module and active peripheral management modules, for example, the customer screen, kiosk, Internet terminal, order taking slate and the like.

The broadcasting module Kdiffu broadcasts elements from the management module to passive peripheral management modules such as kitchen screens (production, assembly), printers (customer or kitchen ticket).

The preparation module Kbussi sends detailed elements of the transaction for BtoB use (Marketing data Base, Procurement line data Base) and input to any “company” application.

The server (14) manages various customer order procedures:

Order type:

on line,

by the staff,

by the staff with customer interaction,

desynchronized,

by the staff or the customer,

with or without payment.

| | | | | | Prep- |
|---|---|---|---|---|---|
| | | | Dialog modules | | aration |
| | | | for order taking | | module |
| Order type | Kcaptu | Kemul | Kcusto | Kdiffu | Kbussi |
| Staff on line | Yes | Yes | | Yes | Yes |
| Staff/customer | Yes | Yes | Yes | Yes | Yes |
| interaction on | | | | | |
| line | | | | | |
| Desynchronized | Yes | Yes | Yes | Yes | Yes |
| (staff or | | | | | |
| customer) | | | | | |
| With payment | Yes | Yes | Yes | Yes | Yes |
| and | | | | | |
| desynchronized | | | | | |

Order taking on line by the staff with customer interaction includes the following steps:

Order input on the cash till

The staff member inputs the customer typology on the cash till and Kcaptu retrieves it in the Kebox

The staff member inputs the customer's order on the cash till

Customer screen display

Kcaptu captures the order as it is input in real time in Kebox.

The server management module translates the contents of the order adapted to the customer using specific rules and a precise format.

explicit descriptions/images of the ordered products

suggestions adapted to the period and the customer profile, previously ordered products, promotions, etc.

Dialog modules for order taking Kcusto send the composed image onto the customer screen.

For the customer screen order, the customer reacts to suggestions displayed by order taking dialog modules Kcusto.

either orally

or by pointing at the touch sensitive screen to confirm acceptance

The order is completed on the cash till

by staff member input in the first case

automatically by Kemul on the second case

Preparation and assembly are done using broadcasting modules Kdiffu that broadcast the order in an appropriate language and in an appropriate presentation according to specific rules and in a precise format, in real time to the peripherals concerned. Details of the transaction are sent in real time by the preparation module Kbussi as soon as the payment is made.

Desynchronized order taking:

Taking orders (a staff member from a portable terminal or customer through a kiosk or Internet) issues a physical identifier for this order, for example, a ticket repeating the order in bar code form. The customer order is transferred from a peripheral communicating with the server. Part or all of the products and the associated suggestions are proposed interactively. The total for the order is calculated and displayed to the customer.

The peripheral controlled by the server issues the customer with a physical identifier for the order (products, amounts in bar code form and the like).

On line order/payment on the cash till.

The cash till takes the order reading the physical identifier provided by the customer (Kemul), and possibly modifying the order. The preparation and assembly may be done using Kebox (Kcaptu, Kdiffu). The preparation module Kbussi sends transaction details in real time as soon as the payment is made.

Order taking and payment are desynchronized (off line)

customer order taken and payment from a kiosk customer order taken and payment by Internet

staff member order taken from a portable terminal and payment by the customer

etc.

Order and payment: dialog order taking modules Kcusto.

The customer order is entered starting from a peripheral communicating with the server. Some or all of the products and associated suggestions are proposed interactively. The entire order is calculated and the peripheral enables any method of payment. If the amount paid is greater than the amount presented, the amount of change is recorded on the Kebox.

The customer and the location at which his order is issued (for example, table number, counter cash till and the like) are identified and given to the customer (for example, ticket) and recorded on Kebox. The detail of the transaction is sent in real time by the Preparation module Kbussi as soon as payment is made.

Order recording: Kemul

After the payment has been made, Kemul passes the order to the cash till that:

makes the legal record of the payment

sends it to any POS peripherals (back office servers, screens).

The broadcasting module Kdiffu notifies the kitchen production and assembly screen.

The invention is described above making use of a non-restrictive example.

What is claimed is:

1. Computer aided sales system intended for use in a retail point of sale comprising at least an order taking equipment, a sales terminal and a server for communication between the different equipment in the system, characterized in that the server comprises means for recording data originating from order taking equipment, and a computer for analyzing data recorded in the said data base in order to generate messages interacting with at least one item of equipment connected to the server.

2. Computer aided sales system according to claim 1, characterized in that the server comprises input-output interfaces for the connection of several types of peripherals, and a data base for the conversion of data formats originating from or intended for the different interconnected equipment, to the specific format for each of the said items of equipment.

3. Computer aided sales system according to claim 2, characterized in that the server comprises a driver for the shop point of sale equipment (POS), providing communication between the data format for the point of sale POS equipment and the unique information format used by the server, and the specific adaptation of the different system means with the POS to enable two-way communication.

4. Computer aided sales system according to claim 1, characterized in that the server comprises a specific database to collect all possible cash till information and translate them in an appropriate manner for their destination peripherals.

5. Computer aided sales system according to claim 4, characterized in that the order taking equipment comprises a computer aided sales module that displays images or animates ordered products and enables the menu to be input (by the customer), and the server comprises a module for statistical analysis and interpretation of the customer's behavior based on the typology of the customer and the time dated record of when the details were entered on the tray.

6. Computer aided sales system according to claim 1, characterized in that the server comprises a communication and warnings module for selectively transmitting warnings in real time (functional or technical) and for the automatic transmission of information to a host system as a function of information recorded in a parameter controlled events table and a state of parameters supplied by system components.

7. Computer aided sales system according to claim 1, characterized in that the server comprises a dialog module for taking orders, that displays and takes interactive orders as a function of real time information from the server, to display information input on the till to the customer, and to return customer selections to the server to modify the order in real time.

8. Computer aided sales system according to claim 1, characterized in that the server comprises a module for broadcasting of elements from the management module to peripheral management modules (passive) for display on a screen or a printer.

9. A retail point of sale computer aided sales system comprising:
at least one order taking device;
a sales terminal; and
a server connected between the order taking device and sales terminal, the server comprising a data recorder that records data originating from the order taking device, and a computer for analyzing data recorded in a data base in the computer to generate messages interacting with at least one of the order taking device or sales terminal connected to the server.

10. The computer aides sales system according to claim 9, wherein the server comprises input-output interfaces for connecting several types of peripherals, and a data base for converting data formats originating from or intended for the order taking device or the sales terminal, to a specific data format for each of the order taking device or the sales terminal.

11. The computer aided sales system according to claim 10, wherein the server further comprises a driver for shop point of sale equipment (POS), provides communication between the data format for the point of sale equipment (POS) and a unique information format used by the server, and a specific adaptation of the order taking device and the sale terminal with the POS which enables two-way communication.

12. The computer aided sales system according to claim 9, wherein the server comprises a specific database to collect all possible cash till information and translate said information such that it is compatible with destination peripherals.

13. The computer aided sales system according to claim 12, wherein the order taking device comprises a computer aided sales module that display images or animates ordered products and enables menu input, and the server comprises a module for statistical analysis and interpretation of customer behavior based on typology of a customer and a time dated record of when information was entered.

14. The computer aided sales system according to claim 9, wherein the server comprises a communication and warnings module for selectively transmitting warnings in real time and for automatic transmission of information to a host system as a function of information recorded in a parameter-controlled events table and a state of parameters supplied by system components.

15. The computer aided sales system according to claim 9, wherein the server comprises a dialog module for taking orders, that displays and takes interactive orders as a function of real time information from the server, to display information input on a till to a customer, and to return customer selections to the server to modify an order in real time.

16. The computer aided sales system according to claim 10, wherein the server comprises a module for broadcasting elements from a management module to peripheral management modules for display on a screen or a printer.
